(19) United States
(12) Patent Application Publication
(10) Pub. No.: US 2003/0115200 A1
(43) Pub. Date: Jun. 19, 2003

(54) Wireless application protocol for real estate data access

(76) Inventors: John J. Anthony, Taftville, CT (US); Kurt D. Kulpa, Manchester, CT (US)

Correspondence Address: Richard C. Litman, LITMAN LAW OFFICES, LTD., P.O. Box 15035, Arlington, VA, 22215, US

(21) Appl. No.: 10/013,363

(22) Filed: Dec. 13, 2001

(51) Int. Cl. G06F 7/00

(52) U.S. Cl. 707/10

(57) ABSTRACT

A wireless system and method which provides data access and retrieval from a Multiple Listing Service or other data store. The system provides access to real estate data and/or information by real estate professionals, field technicians or remote users without the necessity of being confined to an office or behind a desk to do the same. The system uses a web-based or wireless application protocol enabled device such as a cellular phone or personal digital assistant (PDA) within a data store and server network which significantly reduces data access and retrieval time which are primary cost drivers in the wireless industry.

### BACKGROUND OF THE INVENTION

1. Field of the Invention

The present invention relates generally to wireless data transmissions. More specifically, the invention is a system and method for accessing, mining, and retrieving data from remote data stores and/or the Internet with a wireless application protocol enabled device, such as a cellular phone, personal digital assistant (PDA) and the like.

2. Description of the Related Art

Numerous systems have been devised for manipulating data resident in memory or stored within a computer or computer network. Conventional systems which permit data manipulation include INSTINET investment communication systems, computer-based advertisement systems, and data search and retrieval systems as either local interactive stations and/or remote interactive systems. Currently, conventional computer systems, real estate agents, and other qualified professionals have been restricted to accessing multiple listing data sources by conventional technologies such as client servers or web-based applications and others described hereinbelow. In either case, the user is required to be connected to the data source via a wire (such as copper, fiber optics, etc.) to access a desired database.

In some cases, the user may “download” the listing data onto a portable device such as a laptop computer or PDA for later reference. The major disadvantage is that the users are viewing a static copy of the data obtained at an earlier time rather than a dynamic copy of current information obtained from the real estate data source. Currently the only way for the user to view the “latest” data in the real estate data source is to perform the time consuming task of reactivating the “downloading” feature to receive the “latest” data or employ a synchronization mechanism. In either case the burden is on the user to be physically connected to the data source. The wireless system application for accessing data from a remote data store according to the instant invention significantly reduces data access and retrieval times without the problems related to conventional data-base systems.

Computer-based data acquisition systems are described in the U.S. Patents issued to Adams et al. (U.S. Pat. No. 3,573,747), Lalonde et al. (U.S. Pat. No. 5,283,731), Bird et al. (U.S. Pat. No. 5,325,297) and Angelucci et al. (U.S. Pat. No. 6,185,573 B1). U.S. Pat. No. 3,573,747, issued to Adams et al., discloses a method and apparatus for buying and selling properties between subscribers. The system enables anonymous communication between institutional investors for the purpose of developing block trades of listed over the counter trades. The system comprises a centralized data storage unit, a digital computer, a plurality of subscriber terminals with a plurality of communications links established there between.

U.S. Pat. No. 5,283,731, issued to Lalonde et al., discloses a computer-based data retrieval system comprising a data processor and an advertisement database. Profile data which describes an item is processed by the processor and compares the data with stored ads for generating text output data when matches are found, such as want ads, etc. An interactive voice response system converts the text output data into a voice message.

U.S. Pat. No. 5,325,297, issued to Bird et al., discloses a computer implemented method and system for storing and retrieving data representing textual information, and compressed data representing images. Images are scanned into the system, compressed and stored separate and apart from the compressed image data. The stored compressed image data and related textual data which satisfy particular ranges and values for predetermined search criteria are made available in the form of pictorial representations for viewing on a computer display monitor.

U.S. Pat. No. 6,185,573 B1, issued to Angelucci et al., discloses an automated system to input text, audio and video data, to integrate the storage of the data from remote locations at a central location, and to dynamically transmit text, audio and video data to the remote locations depending upon the search criteria. The application is directed to an employment service REZVU^{SM} for generating resume data. An applicant inputs personal and occupational data in the form of text and image data to build a resume profile. The format of the input data form is specified with the Hypertext Markup Language (HTML).

Another class of computer-based data systems is the geographic specific information retrieval system. This type of system is described in the U.S. Patents issued to Tornetta (U.S. Pat. Nos. 4,870,576 and 5,032,989) and Sotiroff et al. (U.S. Pat. No. 5,852,810). The patents issued to Tornetta disclose real estate search and location databases which provide data on properties for potential purchase. Each system includes a graphical locator interface which permits definition of a desired area for search by placement of a user control selector on a cathode-ray-tube (CRT). Having selected a numerical range of data values for a housing listing, a user is then prompted with a series of select menus.

U.S. Pat. No. 5,852,810 issued to Sotiroff et al. discloses a geographic specific information search system and method comprising a World Wide Web (WWW) home page and associated script files for searching for housing information in a desired geographic region. The system is configured to display a graphical map and to allow the user to narrow the geographic search area to a desired region. The system is also configured to accept a query criteria and search a database containing property listings in a conventional fashion. A geographic map of the desired region including properties found during the search is displayed. A document produced under the trademark NEXAGE purports to obtain data listings in a similar fashion, but provides no enablement to support the asserted features.

U.S. Pat. No. 5,561,446, issued to Montlick, describes a wireless method of data retrieval and data entry using pen based terminals, particularly for application in the medical field. U.S. Pat. No. 5,664,115, issued to Fraser, describes a system and method of matching buyers and sellers of real estate over a network which uses telephone or dedicated data transmission lines. U.S. Pat. No. 5,794,216, issued to Brown, discloses a method for storing and retrieving multimedia real estate data and images on a computer readable medium.

U.S. Pat. No. 5,857,174 issued to Dugan discloses a real estate appraisal method in which a buyer of a property assigns points to a subject property and each comparable property based upon an Ideal Point System (IPS). The points assigned, or IPS values are based upon desirability factors for each of five categories. The real property marketing analysis is made by using pr-adjusted appraised comparable sales.

Patents issued and respectively granted to Ayaniglu et al. (U.S. Pat. No. 6,058,422), Lee et al. (EP 1 028 561 A1) and Tanaka (JP 11053409) disclose wireless internet accessing features which are considered to generally relevant to the wireless protocol for real estate data access as herein described.

None of the above inventions and patents, taken either singularly or in combination, is seen to describe the instant invention as claimed. Thus a wireless application protocol for real estate data access solving the aforementioned problems is desired.

### SUMMARY OF THE INVENTION

The wireless system according to the invention provides a system and method for accessing real estate data and/or information using a web-based or wireless application protocol enabled device, such as a cellular phone or personal digital assistant (PDA). The system enables selective data access by real estate professionals, field technicians or remote users in real time without having to be confined to an office or behind a desk, especially when site to site visualization or inspection of real property is a necessity. Data access can be made in accordance with the Wireless Markup Language standard or any other derivative of the Standard Generalized Markup Language (SGML) for subsequent display via a web-enabled mobile phone or PDA. The system includes at least one data store in which real estate and/or other data can also be maintained via a wireless application for mining and retrieving selective data for subsequent transmission or for report formulation in the field. Software written utilizes server-side dynamic content and Wireless Markup Language.

Accordingly, it is a principal object of the invention to provide a wireless system application protocol for mining and retrieving real estate data from at least one data store in realtime.

It is another object of the invention to provide a wireless system application protocol for mining and retrieving real estate data from a data store via a single personal digital assistant (PDA).

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic view of a wireless application protocol for data mining and retrieval according to the present invention.

FIG. 2 is a flow diagram of the wireless application protocol for data mining and retrieval according to the invention.

Similar reference characters denote corresponding features consistently throughout the attached drawings.

### DETAILED DESCRIPTION OF THE PREFERRED EMBODIMENTS

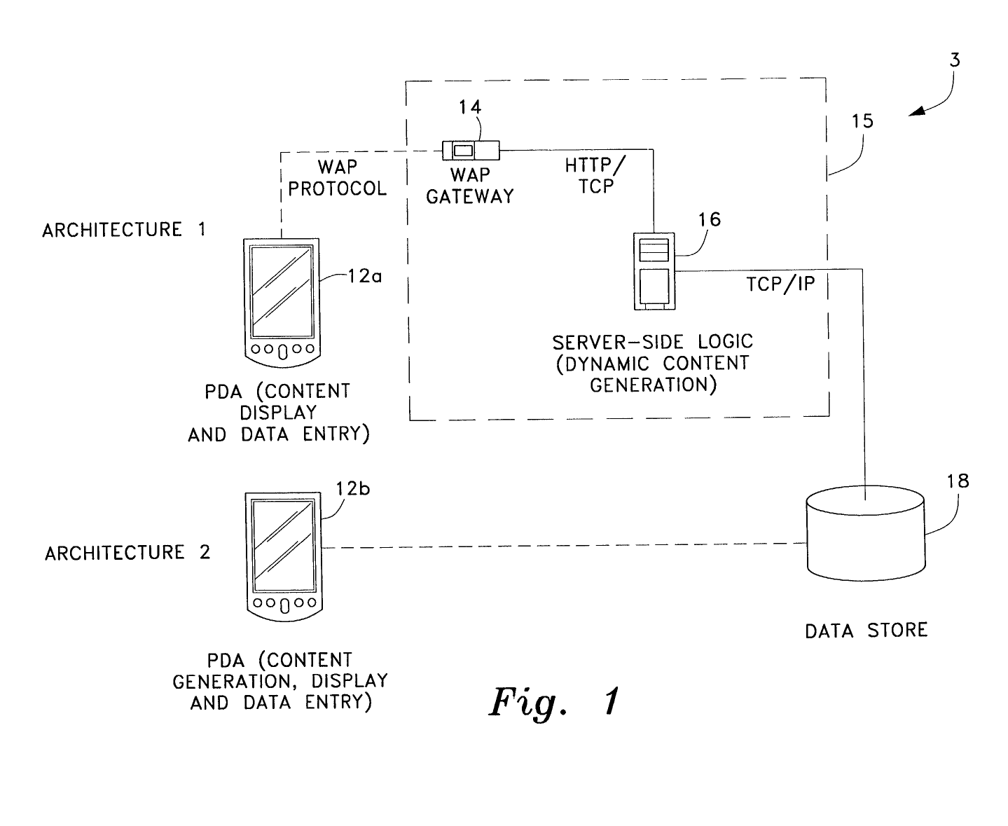

The present invention is directed to a wireless system application protocol for mining and retrieving, in particular, real estate data. However, the system is not limited only to real estate applications. The preferred embodiments of the invention are depicted in FIG. 1, and are generally referenced by numerals 12a and 12b, respectively.

As diagrammatically illustrated in FIG. 1, a dual architecture of the system 3 is shown which includes a first web-enabled device 12a, such as a web-enabled cellular phone or a personal digital assistant (PDA), for wireless accessing of at least one data store 18, and a coupling assembly 15 for coupling the data store 18 to the first web-enabled device 12a for enabling a user to remotely mine and retrieve data from at least one data store 18. The data store 18 is preferably configured as a real estate listing data source which can be queried and mined in real-time by wireless personal devices 12a, 12b.

A second web-enabled device 12b is also shown having a direct wireless link for access to at least one data store 18 for selectively retrieving specific data information from the data store 18. While the dual architecture configuration does include the use of a PDA, the architecture comprising the devices 12a and 12b also includes the utilization of Internet-ready or Internet-enabled mobile phones. One vendor that has been particularly active in developing WAP-compliant Internet-enabled mobile phones is Nokia, the world's biggest makers of mobile phones. Nokia's model 7110 is an exemplary model of the type of WAP-enabled device 12a used.

Several innovative features make this particular model faster and easier to access Internet information such as a large display with 65 rows of 96 pixels, microbrowser, navi-roller or built-in mouse and predictive text input—as a user presses various keys to spell words a built-in dictionary continually compares the word in progress with words in a database or data store 18. The WAP standard includes its own Wireless Markup Language (WML) and thus cannot be used to access just any Web site as an inherently secure feature. The WML standard is a simple version of the Hypertext Markup Language (HTML), but has the strength of spanning multiple airlink standards which enable content publishers and application developers to be unconcerned about the specific delivery mechanism.

This configuration provides users with access to Web content applications, including the ability to participate in electronic commerce transactions, delivered through the Wireless Application Protocol (WAP). WAP is an open, global specification that empowers mobile users with wireless access to information services instantly. The first beneficiary of WAP-enabled business applications is notably the financial services industry, however more business industries are embracing the WAP technology, primarily because e-business transactions with financial institutions provides numerous modes and methods of doing business. WAP also enables users to access news services to retrieve general news, sports news and financial news up-to-the minute.

Currently, conventional computer systems, real estate agents, other qualified professionals, and general users (hereafter referred to as “the agent”) are restricted to accessing the multiple listing data source 18 by conventional technologies, such as client servers or web-based applications. In both cases, the agent is required to be connected to the data source 18 via a wire (such as copper, fiber optics, etc.). In some cases, the agent may “download” the listing data from a desk-top or mainframe computer onto a portable device, such as a laptop computer, for later use when the agent is away from the office or other fixed location data terminal. The major disadvantage is that the agents are viewing a static copy of the data that was in the real estate data source 18 at the time of download. The only way for the agent to view the “latest” data in the real estate data source 18 is to perform the time consuming task of reactivating the “downloading” feature to receive the “latest” data or to employ a synchronization mechanism, such as a modem connected to a telephone or other data transmission line. In other cases, the real estate agent may utilize a cellular phone that is able to act as a modem to access certain data in the real estate data source, but analog signals are known to have inherent signal “packaging” set backs or signal/data losses which produces unreliable results. Nevertheless, the access to the data is made in real time, however the major disadvantage is that the agent requires the use of numerous hardware elements such as modems, laptops, special displays, etc. which become difficult to manipulate and/or use in the field.

Accordingly, the wireless system 3 includes a first configuration wherein the coupling assembly 15 comprises a WAP gateway 14 and a WML-enabled server 16 which are interconnected with at least one data store 18 via a TCP/IP network or similar network. The server 16 mines the data store 18 based on search parameters passed by the user through the WML interface. This method of the wireless protocol is described in more detail below.

In either configuration, the wireless system 3 includes a web-enabled device 12a, 12b configured with a programmable software code which permits translation of dynamically generated results of queries made in WML for display and subsequent use (i.e. wireless data transmission to a remote location, printer, etc) by the user or agent. In the case of the architecture comprising PDA 12b, the computer code or software logic for mining the real estate data is within the client-side application code that resides on the PDA 12b, thereby eliminating the need for an intermediate server 16. With the utilization of a WAP-enabled cellular phone as the PDA 12a, Java may be used as the Server-side logic, with Tomcat used as the Webserver and Microsoft SQL Server as the data store. Any one of these components can be replaced by an equivalent form of technology and still fulfill the intent and purpose of the invention as herein disclosed. For example, Active Server Pages could be used with the Microsoft Internet Information Server (IIS) for the server-side logic using an Extensible Markup Language (XML) based data store, an Oracle data store, or other commercially available data store such as Microsoft Access, etc.

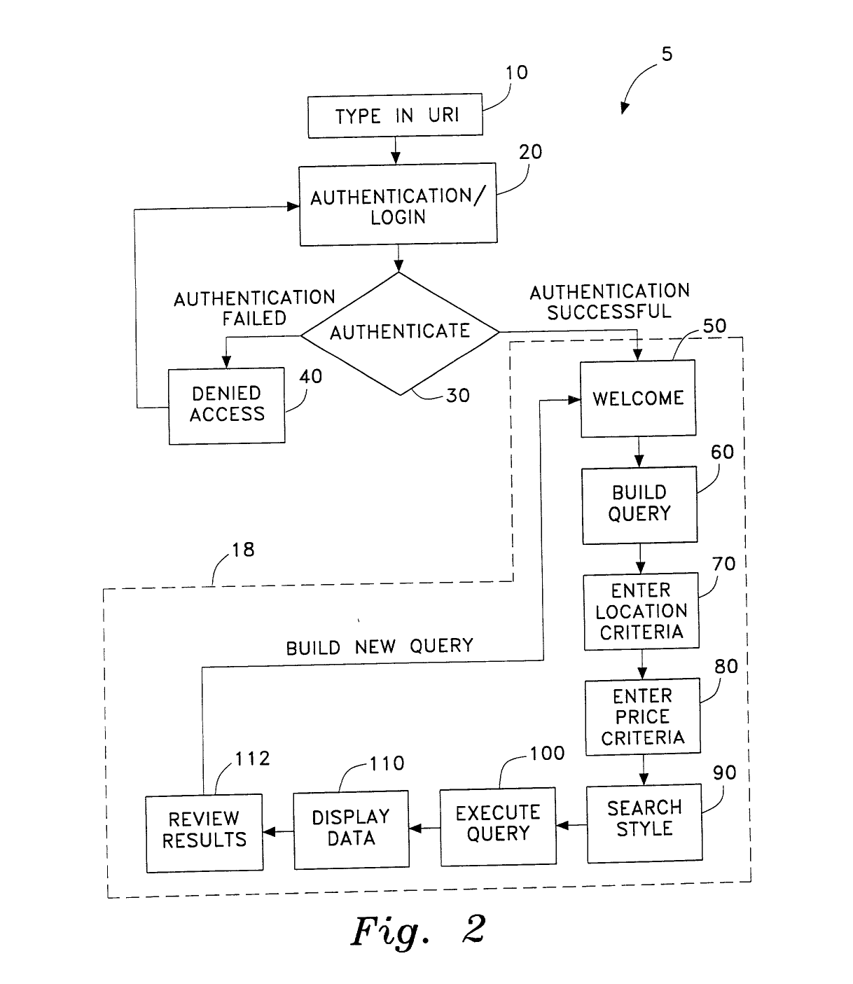

As illustrated in FIG. 2, the method 5 for mining and retrieving real estate data, such as a Multiple Listing Service (MLS), from a data store according to the wireless application protocol include the general steps of:

a) inputting 10 a uniform resource identifier (URI) such as a uniform resource locator (URL), name, address or access code having a predetermined character scheme and number within a web-enabled device;

b) authenticating login via steps 20, 30 and 40, if trying to view restricted information and displaying a welcome screen 50 to the data store 18;

c) building a query 60 by entering selective field data; (the following data fields are listed as exemplary, and can include any number of other data fields:)

d) entering location 70 criteria;

e) entering price 80 criteria;

f) selecting a search style 90 utilizing a predetermined data store selection format; and

g) executing the query 100. The executing step g) further includes the steps of:

g0) mining the data in the data store based on the parameters entered in the respective steps of (d), (e), and (f) recited above (it is noted, however, that other parameters can be used to refine the respective search)

g1) displaying data 110; and

g2) reviewing results 112 in a selective format as a custom programmable feature. The results can be produced in hard copy format or sent via Internet and/or e-mail to a remote location.

Since incidence of fraud (i.e. cloning, rechipping, scanning and utilization of false accounts) have become common place in the area of mobile technology, a number of fraud-control techniques have been developed to discourage attempts at mobile-phone related fraud which include the use of personal identification numbers, calling-pattern analysis, authentication, radio-frequency fingerprinting and voice verification. In this regard, the wireless application protocol for doing business over the Internet includes an authenticating step when trying to view restricted information which further comprises the steps of:

b1) denying access 40 based on the input data; and

b2) returning to the authenticating login step 20 for authenticating a successful entry to at least one data store 18 with a welcome display 50. Once within a respective data store a user can execute or build at any time a new query or simply log-off as an inherent programmable log out feature.

It is to be understood that the present invention is not limited to the embodiments described above, but encompasses any and all embodiments within the scope of the following claims.

I claim:

1. A wireless system application protocol for mining and retrieving real estate data comprising:
at least one database for retaining accessible data;
a first wireless application protocol enabled device for wireless access to said at least one database;
a coupling assembly for coupling said at least one database to said first wireless application protocol enabled device for remotely mining and retrieving data from said at least one data store; and
a second wireless application protocol enabled device having software means residing thereon for wireless access to said at least one database for selectively retrieving data from said at least one database.

2. The wireless system according to claim 1, wherein said coupling assembly comprises a gateway and a server being interconnected with said at least one database by a TCP/IP network.

3. The wireless system according to claim 1, wherein said first and second means are web-enabled devices.

4. The wireless system according to claim 1, wherein said wireless application protocol enabled devices are personal digital assistants.

5. The wireless system according to claim 4, wherein said devices are configured with a programmable software code for wireless data transmission.

6. A wireless application protocol method for mining and retrieving real estate data from a data store comprising, the steps of:
a) inputting a uniform resource identifier within a wireless application protocol enabled device;
b) entering and authenticating login data;
c) building a query;
d) entering location criteria;
e) entering price criteria;
f) selecting a search style; and
g) executing the query.

7. The wireless application protocol method according to claim 6, wherein step b) further includes the steps of:
denying access based on said input data; and
returning to the authenticating login step b) for authenticating successful entry to at least one data store with a welcome.

8. The wireless application protocol method according to claim 6, wherein step g) further includes the steps of:
displaying data; and
reviewing results.

9. The wireless application protocol method according to claim 8, wherein said executing step g) further includes the step of:
h) building a new query.
